(19) United States
(12) Patent Application Publication
(10) Pub. No.: US 2002/0089469 A1
(43) Pub. Date: Jul. 11, 2002

(54) Foldable head mounted display system

(76) Inventors: George W. Cone, Sammamish, WA (US); Josh Hansen, Everett, WA (US); Joel Robinson, Seattle, WA (US)

Correspondence Address: McANDREWS, HELD & MALLOY, LTD., 34th Floor, 500 W. Madison Street, Chicago, IL, 60661, US

(21) Appl. No.: 09/755,324

(22) Filed: Jan. 5, 2001

(51) Int. Cl. G09G 5/00

(52) U.S. Cl. 345/8

(57) ABSTRACT

A head mounted display system includes an image display module for generating a virtual image mounted on a frame to be worn on a user's head. The frame includes a front portion and a pair of temples that are adjustable in length and in tension to accommodate users of various head sizes. The system is further foldable for storage with an eye blocker forming a protective cover for the optical surface of the image display module when it is not in use. A microphone is incorporated into the housing of the image display module to pick up a user's voice and provide hands free operation of the head mounted display system.

### CROSS-REFERENCE TO RELATED APPLICATIONS

N/A

### STATEMENT REGARDING FEDERALLY SPONSORED RESEARCH OR DEVELOPMENT

N/A

### TECHNICAL FIELD

The present invention relates to a head mounted display system having an image display module that generates a virtual image mounted on a frame and more particularly, to such a head mounted display system that is adjustable, foldable and permits hands free operation.

### BACKGROUND OF THE INVENTION

Head mounted display systems are known that include a frame worn on the user's head and a monocular or binocular virtual image generating system mounted on the frame. Typical frames for head mounted display systems provide little or no adjustment to accommodate different head sizes among users. Because of the weight of the image generating system, the frame must fit the user's head snugly so as to be able to maintain the system in the proper position for viewing the virtual image without slipping. However, if the frame is too snug, the head mounted display system can be uncomfortable to wear. Because head sizes among users varies greatly, it is difficult to provide a head mounted display system that can be worn by a large number of users.

Further, the frame of the typical head mounted display system is not foldable so that the unit is bulky to store or carry when it is not in use. Moreover, the optical surface of the image display module into which the user looks to view an image can be scratched when the unit is not in use, impairing the virtual image.

### BRIEF SUMMARY OF THE INVENTION

In accordance with the present invention, the disadvantages of prior head mounted display systems have been overcome. The head mounted display system of the present invention includes a frame to be worn on a user's head and an image display module supported on the frame and having an exit surface at which the user looks to see a virtual image. The head mounted display system is foldable, adjustable and permits hands free operation.

In accordance with one feature of the present invention, the image display module is a monocular unit such that the virtual image is viewed by only one of the user's eyes. In this embodiment, an eye blocker is mounted on the image display module for movement between a first position and a second position. In the first position, the eye blocker substantially blocks at least a portion of the view of the user's non-image viewing eye to overcome problems with eye dominance and the like. In the second position, the eye blocker covers the exit surface of the image display module so as to protect this optical surface when the system is not in use.

In accordance with another feature of the present invention, a microphone is mounted on a lower portion of the image display module so as to pick up a user's voice. This feature of the present invention allows hands free operation of the virtual image display without adding additional bulk to the system since the microphone is incorporated into the image display module itself as opposed to being mounted on an additional component.

In accordance with a further feature of the present invention, the frame includes a pair of temples each having an associated tension adjustment knob. Each tension adjustment knob is coupled to an end of a respective temple to vary a force applied to the temple end in a direction that is generally perpendicular to the length of the temple as the adjustment knob is moved. As the force applied to the one end of the temple is increased, the other end of the temple is directed inward to tighten the fit of the frame on the user's head. Moving the adjustment knob in an opposite direction decreases the force applied to loosen the fit of the frame on the user's head. This feature allows a single head mounted display system to comfortably accommodate users having different head sizes.

To further accommodate different head sizes, the length of the temples may be adjusted. More particularly, each temple has a first section and a second section that are mateable at different positions along the length of the temple to allow the length of the temple to be increased or decreased.

The temples of the frame are hinged to a front section of the frame so that the temples may be folded when the head mounted display system is not in use. The image display module is supported on the frame by an arm that is mounted on one of the temples for slideable movement along a portion of the length of the temple. When the system is in use, this feature allows the user to move the image display module towards and away from the eye to vary the viewing distance and it enables the system to accommodate users who wear glasses. When the system is not in use and the temples are folded for storage, the slideable mounting allows the image display module to be moved into a position closer to the frame so as to provide a more compact unit for storage.

These and other advantages and novel features of the present invention, as well as details of an illustrated embodiment thereof, will be more fully understood from the following description and drawings.

### BRIEF DESCRIPTION OF THE SEVERAL VIEWS OF THE DRAWING

FIG. 1 is a front perspective view of the head mounted display system of the present invention with the eye blocker in its in-use position;

FIG. 2 is a back view of the image display module and eye blocker of FIG. 1 in the in-use position;

FIG. 3 is a back view of the image display module and eye blocker of FIG. 1 in its closed or storage position;

FIG. 4 is a top view of the image display module and eye blocker in the in-use position;

FIG. 5 is a top cross-sectional view illustrating the coupling of the tension adjustment knob to an end of a respective temple of the frame of the head mounted display system; and

FIG. 6 is a partial, inner side view of the first and second temple portions that are mateable so as to increase or decrease the length of the temple.

### DETAILED DESCRIPTION OF THE INVENTION

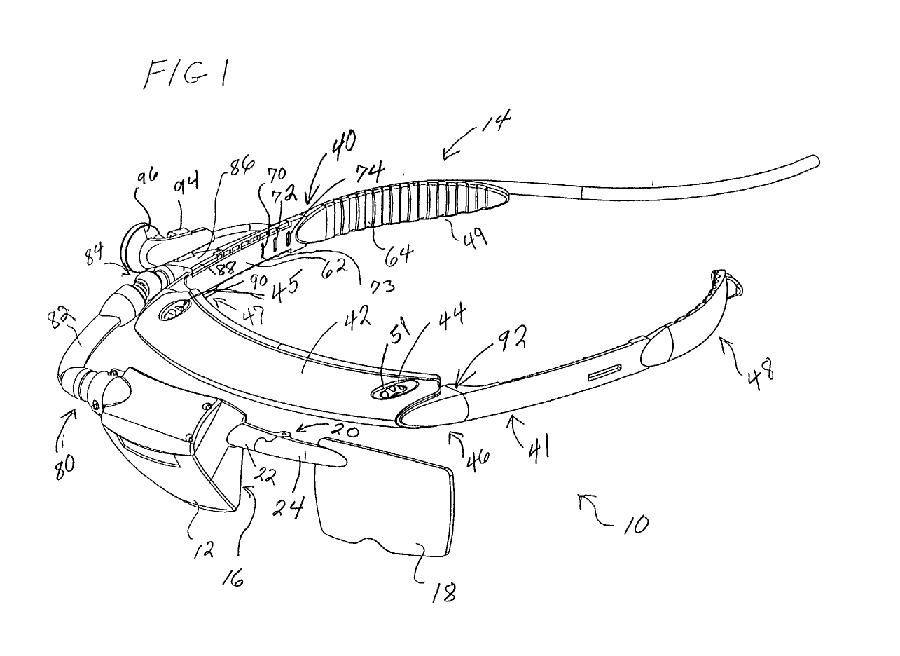

One embodiment of a head mounted display system 10 in accordance with the present invention as shown in FIG. 1 includes an image display module 12 that is supported on a frame 14 to be worn on a user's head. The image display module 12 may be a binocular module that generates images viewable by both of the user's eyes. Alternatively, the image display module 12 may be a monocular module as shown, the module 12 generating a virtual image that is viewed by only one of the user's eyes. The virtual image display module 12 includes an image source and one or more optics for enlarging the image from the source and to correct for distortions in the image. Light from the image source and optic(s) is directed through an exit surface 16 of the image display module 12 so as to reach the user's eye such that when the user looks into the exit surface 16 the user sees a virtual image that is enlarged and appears at a distance from the user that is much greater than the distance from the exit surface 16 to the user's eye. A suitable image display module includes a microdisplay and minimal optics as shown in U.S. patent application Ser. No. 09/645,219 filed Aug. 24, 2000 entitled “Virtual Imaging System With Solid Optics” and incorporated herein by reference. This image display module is extremely lightweight and compact.

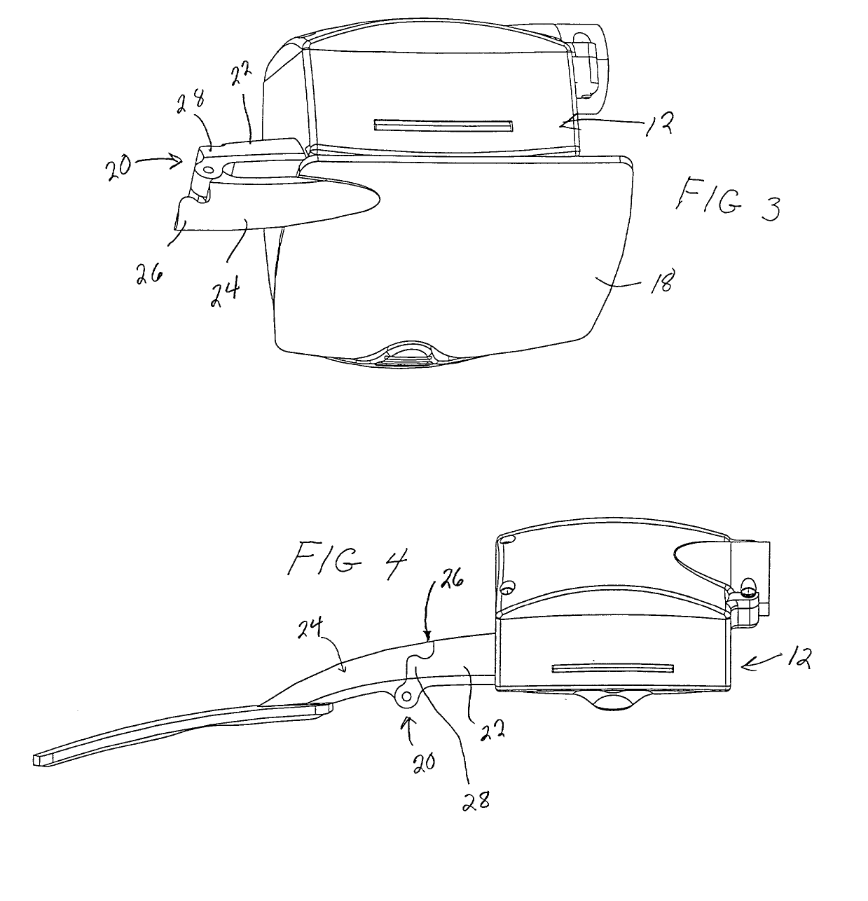

An eye blocker 18 is mounted on the image display module for movement between a first or in-use position, as shown in FIGS. 1, 2 and 4, and a second or storage position as shown in FIG. 3. In the first or in-use position, the eye blocker substantially blocks a portion of the view of the user's non-image viewing eye to overcome problems of eye dominance. In the second position, the eye blocker covers the exit surface 16 of the image display module to protect the exit surface which is a lens or the like, from being scratched. The eye blocker 18 may be formed of a material that completely blocks light from passing therethrough. Alternatively, the eye blocker can be made of a material that allows some light through but blocks a substantial portion thereof, such as a transparent material with a dark tint. The size of the eye blocker 18 is such that it does not have to block the entire view of the user's non-image viewing eye but only a portion thereof so as to overcome problems with eye dominance, etc. that can impair the viewing of an image with one eye. However, the eye blocker 18 is preferably large enough so as to cover at least the exit surface 16 of the image display module when the eye blocker is in the second or storage position. The eye blocker 18 is mounted on a hinge member 20 having a side 22 connected to the image display module 12 and a side 24 connected to the eye blocker 18 to allow the eye blocker to be pivoted from the first or in-use position to the second or storage position. An end 26 of the hinge side 24 is contoured to engage an end 28 of the hinge side 22 that is shaped with a mating contour. The end 26 engages the end 28 to securely hold the eye blocker 18 in the in-use position. When the ends 26 and 28 are disengaged, the eye blocker can be moved to the second or storage position of FIG. 3, in which the eye blocker 18 covers the exit surface of the image display module. It is noted that although binocular head mounted display systems do not use eye blockers, a hinged cover for the exit surface of the binocular image display system can be employed to protect the image display module for storage as well. In such an embodiment, the hinged cover 18 would be mounted on a different side of the image display module than as shown in FIGS. 1-4 so that it would not interfere with a second image generator.

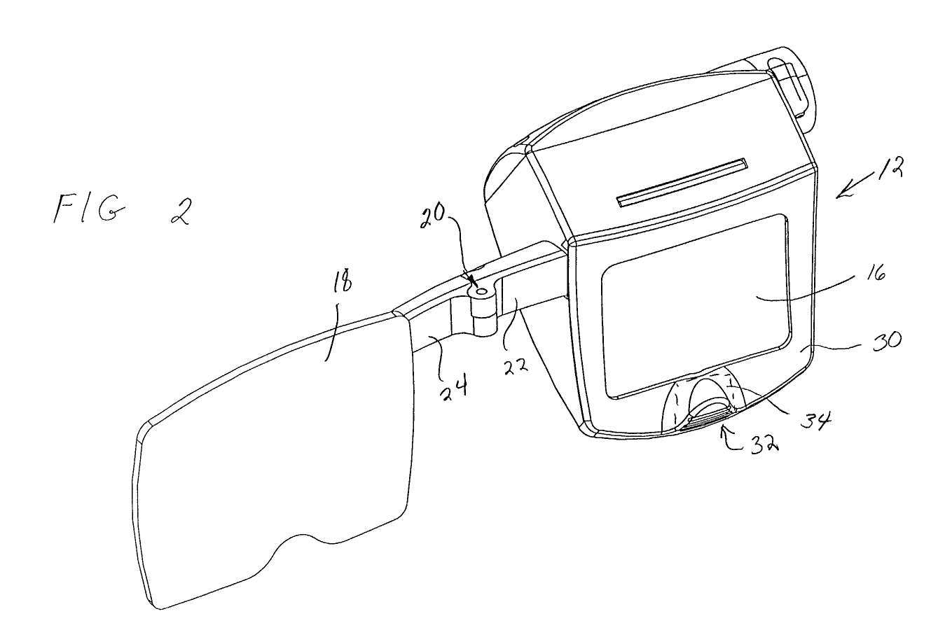

As shown in FIG. 2, a lower portion of the housing 30 of the image display module 12 includes an input 32 for a microphone 34 mounted in the housing 30. The microphone 34 is positioned in the lower portion of the image display module housing to pick up a user's voice for hands free operation of the image display module. In a preferred embodiment, the microphone is a noise canceling microphone. Placement of the microphone 34 in the image display module itself, eliminates the need for an additional component to mount the microphone on the frame 14. It is noted, that the eye blocker 18 is contoured at its lower edge so as to accommodate the microphone input 32 when the eye blocker is in its close position as shown in FIG. 3.

The frame 14 of the head mounted display system 10 includes a pair of temples 40 and 41 mounted on opposite sides of the frame's front portion 42. The front portion 42 of the frame 14 forms a visor to shade the exit surface 16 of the image display module 12 from direct light so that the virtual image may be more easily seen. In order to provide a tighter or looser fit for the frame 14 on a user's head, a pair of adjustment knobs 44, 45 are provided on respective sides of the front portion 42 adjacent respective ends 46, 47 of the temples 41, 40. Each of the adjustment knobs 44, 45 is coupled to a respective temple end 46, 47 so as to apply a force on the temple end 46, 47. As the force is increased, by rotating the adjustment knob in one direction, the temple is moved inward and tightened against the user's head. As the force is decreased by rotating the adjustment knob in a second direction, the fit is loosened.

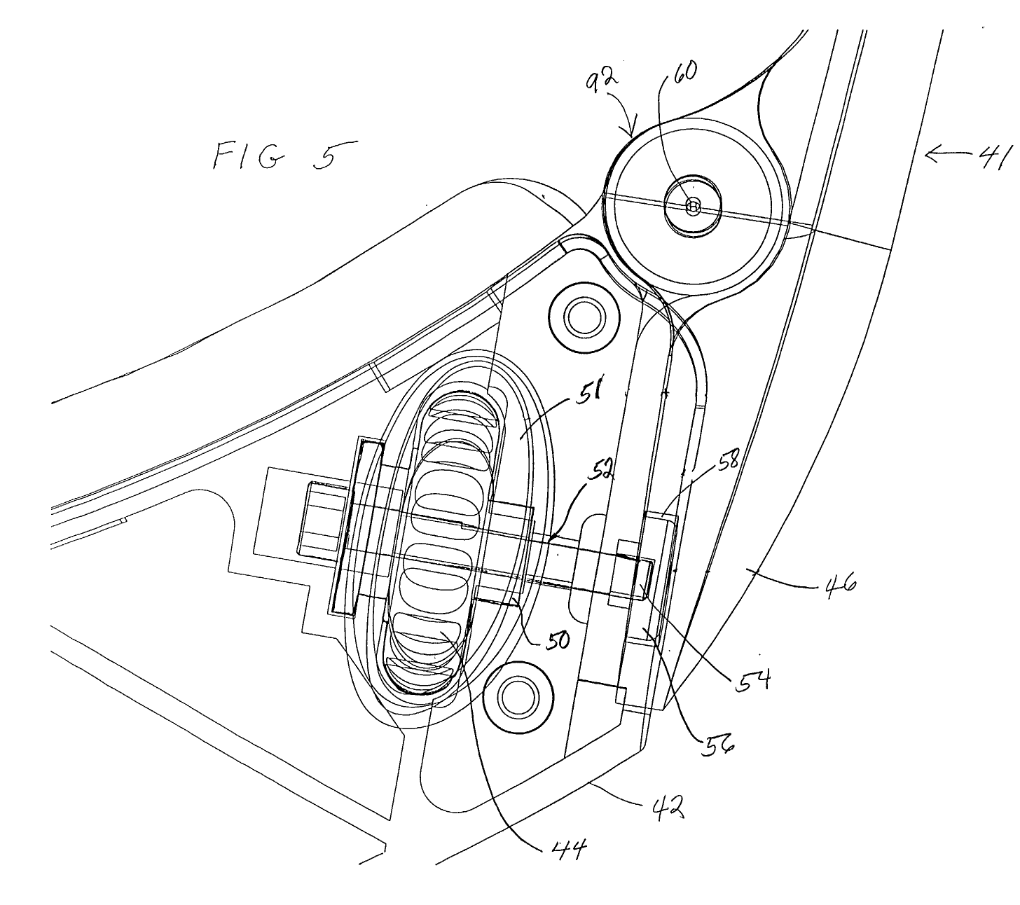

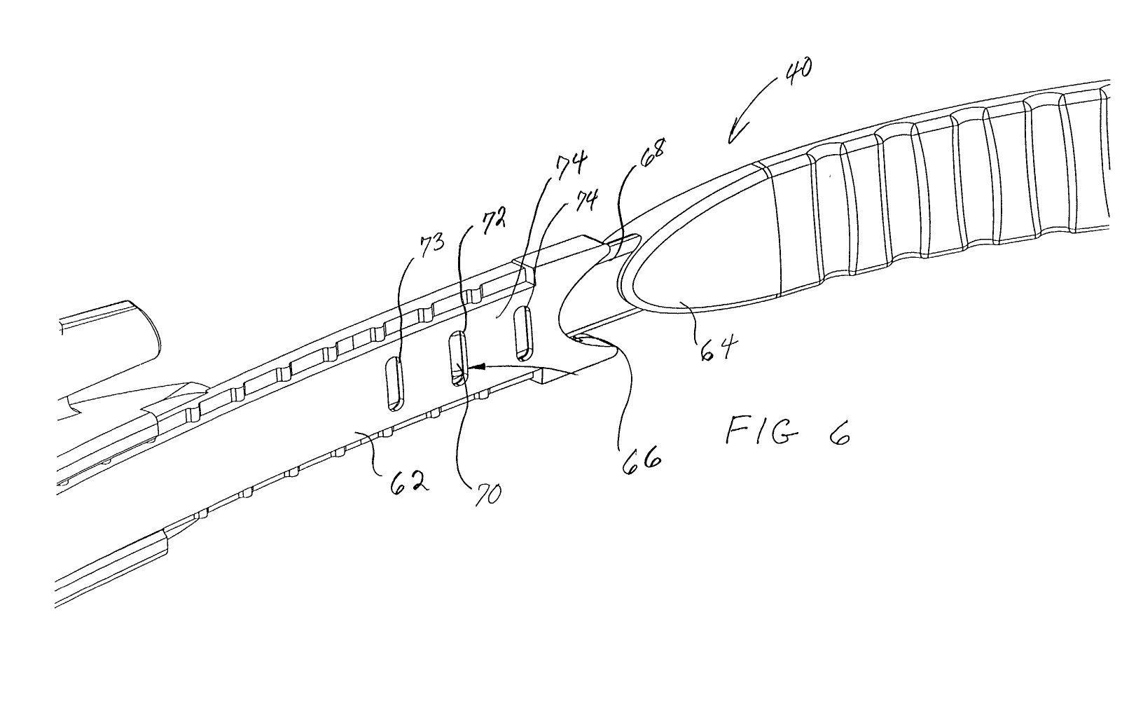

The tension adjustment for the frame 14 is shown in detail in FIG. 5 for the adjustment knob 44 and temple 41. The adjustment knob 44 is mounted on a collar 50 contained in the front portion housing 42, a portion of the knob 44 extending through an opening 51 in the housing 42 so that the knob can be moved by a user. The collar 50 engages a screw 52 so as to rotate the screw 52 as the knob 44 is moved in a direction generally parallel to the length of the temple. An end 54 of the screw 52 abuts a tension pad 56 contained in an aperture 58 of the temple end 46. As the screw 52 is rotated in one direction by the knob 44, the screw end 54 applies a force against the temple end 46 in a direction generally perpendicular to the length of the temple. This force causes the temple 41 to pivot about a pivot point 60 so that the opposite end 48 of the temple 41 moves inward exerting a greater force or tension against the user's head to tighten the frame 14 on the head. As the screw is rotated in an opposite direction by the knob 44, the force applied by the screw 52 against the temple end 46 is reduced so as to loosen the frame 14 on the user's head. The tension adjustment mechanisms provided by the adjustment knobs 44 and 45 for the temples 41 and 40 allow the frame 14 to accommodate a wide range of head sizes to securely but comfortably maintain the frame in the correct position on the user's head without slippage.

As shown in FIGS. 1 and 6, each of the temples 40 and 41 has a length that is extendable and retractable so as to accommodate heads of various sizes and to allow the temples to extend beyond the sides of the head and partially around the back thereof for a more secure fit. Each temple is formed with at least two sections 62 and 64 as shown for the temple 40 in FIG. 6. The sections 62 and 64 are mateable at different positions along the length of the temple to allow the length of the temple to be increased or decreased. The temple section 62 includes an elongated aperture or slot 66 formed therein so as to receive an end 68 of the temple portion 64. The end 68 of the temple portion 64 has at least one protrusion 70 extending outwardly from a surface thereof wherein the protrusion 70 mates with an aperture 72 formed in an inner side wall 74 of the temple portion 62. The side wall 74 of the temple portion 62 has several apertures 72, 73, 74 extending along the length thereof for accepting the protrusion 70 of the second portion 64 at various positions to extend or retract the temple. When the protrusion 70 engages the aperture 73 closest to the front portion 42, the temple 40 is in its retracted position. The length of the temple 40 is extended by pulling the temple portion 64 out so that the protrusion 70 engages a different aperture 72 or 74 along the length of the temple portion 62. When the protrusion 70 of the temple portion 64 engages the aperture 74, the temple length is fully extended. It is noted that although three apertures are shown, the number of apertures can vary.

As shown in FIG. 1, the image display module is mounted on one end 80 of an arm 82, the opposite end 84 of the arm 82 being mounted on the temple 40. When mounted on the temple 40, the image display module 12 is positioned in front of the user's right eye. A ball and socket connection at each of the ends 80 and 84 of the rigid arm 82 allows the image display module to be rotated or tilted; to be moved up and down; and to be moved to the right and left so as to position the exit surface 16 of the module in the correct viewing position for a particular user. The ball and socket connection 84 connects the arm 82 to a mounting member 86 having a pair of flanges 88 and 90 that engage the temple 40 but that allow the mounting member 86 to slide along a portion of the length of the temple 40. In particular, the mounting member 86 slides along the length of the temple section 62. By sliding the mounting member 86 along the length of the temple section 62, the image display module 12 can be moved towards or away from the user's eye. This feature allows the image display module to be adjusted to provide a desired viewing distance from the exit surface 16 for a particular user. It also allows the head mounted display system 10 to be worn with a pair of glasses. It is noted that each of the temples 40 and 41 includes a hinge 92 so as to allow the temples to be folded in towards the front portion 42. When the temples are folded for storage, the mounting member 86 can be slid back towards the temple portion 64 to move the image display module 12 into a more compact storage position. The mounting member 86 also includes a bracket 94 to retain a speaker ear piece 96 when it is not in use.

The head mounted display system 10 is fully adjustable so as to accommodate different users. It is further foldable so as to provide a compact unit for storage wherein the optical surface 16 of the image display module is protected. Many modifications and variations of the present invention are possible in light of the above teachings. Thus, it is to be understood that, within the scope of the appended claims, the invention may be practiced otherwise than as described hereinabove.

What is claimed and desired to be secured by Letters Patent is:

1. A head mounted display system comprising:
a frame to be worn on a user's head;
an image display module supported on the frame so as to be positioned relative to one of the user's eyes, the module generating a virtual image and having an exit surface at which the user looks to see the virtual image;
an eye blocker mounted on the image display module for movement between a first position in which the eye blocker substantially blocks at least a portion of the view of the user's other eye and a second position in which the eye blocker covers the exit surface of the image display module.

2. A head mounted display system as recited in claim 1 further including a hinge member having a first side connected to the image display module and a second side connected to the eye blocker to allow the eye blocker to be pivoted from the first position to the second position.

3. A head mounted display system as recited in claim 1 wherein said second side of the hinge member has an end that engages an end of the first side of the hinge member when the eye blocker is in the first position to hold the eye blocker in the first position.

4. A head mounted display system as recited in claim 1 wherein the image display module includes a microphone mounted in a lower portion thereof so as to pick up the user's voice.

5. A head mounted display system as recited in claim 4 wherein a voice input area of the microphone is positioned adjacent the exit surface of the image display area and the eye blocker is shaped to accommodate the voice input area when in the second position.

6. A head mounted display system as recited in claim 1 wherein the frame includes a pair of temples, each temple having a length that is extendable and retractable to accommodate heads of different sizes.

7. A head mounted display system as recited in claim 1 wherein the frame includes a pair of temples, each temple having first and second sections that are mateable at different positions along a portion of the length of the temple to allow the length of the temple to be increased or decreased.

8. A head mounted display system as recited in claim 7 wherein each first temple section includes an elongated aperture to allow an end of the second temple section to be inserted therein, the end of the second temple section including at least one protrusion mateable with one of a plurality of apertures formed in a wall of the first temple section to set the length of the temple.

9. A head mounted display system as recited in claim 1 wherein the frame includes a front position, a pair to temples mounted on opposite sides of the front portion and a pair of adjustment knobs, each adjustment knob being mounted on the front portion of the frame and coupled to an end of a respective temple to vary a force applied to the temple end in a direction generally perpendicular to the length of the temple as the knob is moved.

10. A head mounted display system as recited in claim 8 wherein each of the adjustment knobs is coupled to a respective screw to rotate the screw as the adjustment knob is moved, the screw having an end that applies the force to the respective temple end, the force varying as the screw is rotated by the knob.

11. A head mounted display system as recited in claim 1 wherein the frame includes a pair of temples and the image display module is supported on the frame by an arm that is mounted on one of said temples for slideable movement along a portion of the length of the temple.

12. A head mounted display system comprising:
an image display module for generating a virtual image viewable by a user; and
a frame for supporting the image display module on a user's head, the frame having a front portion, a pair of temples mounted on opposite sides of the front portion and an adjustment knob associated with each of the temples, the adjustment knob being coupled to an end of the associated temple to move at least a portion of the temple inward towards the user's head as the knob is moved.

13. A head mounted display system as recited in claim 12 wherein each of the temples is extendable to increase the length thereof.

14. A head mounted display system comprising:
an image display module for generating a virtual image viewable by a user; and
a frame for supporting the image display module on a user's head, the frame having a front portion, a pair of temples mounted on opposite sides of the front portion and an adjustment knob associated with each of the temples, the adjustment knob being coupled to an end of the associated temple to vary a force applied to the temple end in a direction generally perpendicular to the length of the temple as the knob is moved.

15. A head mounted display system as recited in claim 14 wherein each of the adjustment knobs is coupled to a respective screw to rotate the screw as the adjustment knob is moved, the screw having an end that applies the force to the respective temple end, the force varying as the screw is rotated by the knob.

16. A head mounted display system as recited in claim 14 wherein each of the temples includes a hinge to mount the temple on the front portion of the frame and to allow the temple to be folded, the temple including a first section on one side of the hinge having the end to which the knob is coupled and a second section on an opposite side of the hinge.

17. A head mounted display system as recited in claim 14 wherein each of the temples is extendable to increase the length thereof.

18. A head mounted display system as recited in claim 17 wherein each temple includes first and second sections that are mateable at different positions along a portion of the length of the temple to allow the length of the temple to be increased or decreased.

19. A head mounted display system as recited in claim 18 wherein each first temple section includes an elongated aperture to allow an end of the second temple section to be inserted therein, the end of the second temple section including at least one protrusion mateable with one of a plurality of apertures formed in a wall of the first temple section to set the length of the temple.

20. A head mounted display system as recited in claim 14 wherein the image display module includes a microphone mounted in a lower portion thereof so as to pick up the user's voice.

21. A head mounted display system as recited in claim 14 wherein the frame includes a pair of temples and the image display module is supported on the frame by an arm that is mounted on one of said temples for slideable movement along a portion of the length of the temple to vary the distance between the image display module and a user's eye

22. A head mounted display system as recited in claim 21 wherein the image display module includes an image source and at least one optic and is mounted for rotation on said arm.

23. A head mounted display system as recited in claim 22 wherein said image display module is moveable in a direction generally parallel to the length of the front portion of the frame.

24. A head mounted display system comprising:
an image display module for generating a virtual image viewable by a user; and
a frame for supporting the image display module on a user's head, the frame having a front portion, a pair of temples mounted on opposite sides of the front portion wherein each of the temples is extendable to increase the length of the temple and retractable to decrease the length of the temple.

25. A head mounted display system as recited in claim 24 wherein each temple includes first and second sections that are mateable at different positions along a portion of the length of the temple to allow the length to be increased or decreased.

26. A head mounted display system as recited in claim 25 wherein each first temple section includes an elongated aperture to allow an end of the second temple section to be inserted therein, the end of the second temple section including at least one protrusion mateable with one of a plurality of apertures formed in a wall of the first temple section to set the length of the temple.

27. A head mounted display system as recited in claim 24 wherein the image display module includes a microphone mounted in a lower portion thereof so as to pick up the user's voice.

28. A head mounted display system as recited in claim 24 wherein the frame includes a pair of temples and the image display module is supported on the frame by an arm that is mounted on one of said temples for slideable movement along a portion of the length of the temple to vary the distance between the image display module and a user's eye

29. A head mounted display system as recited in claim 28 wherein the image display module includes an image source and at least one optic and is mounted for rotation on said arm.

30. A head mounted display system as recited in claim 29 wherein said image display module is moveable in a direction generally parallel to the length of the front portion of the frame.

31. A head mounted display system comprising:
a frame to be worn on a user's head;
an image display module supported on the frame, the image display module including a housing and a display and at least one optic contained therein for generating a virtual image viewable by the user; and
a microphone to pick up a user's voice mounted in the housing of the image display module.

32. A head mounted display system as recited in claim 31 wherein the frame includes a pair of temples and the image display module is supported on the frame by an arm that is mounted on one of said temples for slideable movement along a portion of the length of the temple to vary the distance between the image display module and a user's eye and mouth.

33. A head mounted display system as recited in claim 32 wherein the image display module is mounted for rotation on said arm.

34. A head mounted display system as recited in claim 33 wherein said image display module is moveable in a direction generally parallel to the length of a front portion of the frame.

35. A head mounted display system comprising:
a frame to be worn on a user's head;
an image display module supported on the frame so as to be positioned relative to one of the user's eyes, the module generating a virtual image and having an exit surface at which the user looks to see the virtual image;
a cover mounted on the image display module for movement between a closed position in which the cover is positioned over the exit surface of the image display module and an open position in which the cover does not obstruct the exit surface of the image display module.
